(19) United States
(12) Patent Application Publication
(10) Pub. No.: US 2012/0274558 A1
(43) Pub. Date: Nov. 1, 2012

(54) APPARATUS AND METHODS FOR OPERATING A CURSOR MANIPULATION DEVICE AT MULTIPLE RESOLUTIONS

(76) Inventors: Joseph Broms, Glen Carbon, IL (US); Sheryl LeDuc, Gold Canyon, AZ (US); Arie Friesen, Queen Creek, AZ (US); John Platt, Valley Park, MO (US); Larry Klingler, Mesa, AZ (US); Christine Ford, Maplewood, MO (US)

(21) Appl. No.: 13/432,033

(22) Filed: Mar. 28, 2012

Related U.S. Application Data
(60) Provisional application No. 61/468,376, filed on Mar. 28, 2011.

(51) Int. Cl. G09G 5/08; G06F 3/033

(52) U.S. Cl. 345/157

(57) ABSTRACT

A method of using a cursor control signal from a cursor manipulation device to move a cursor in a composite display having a native portion controlled by a native computer system and at least one non-native portion apportioned to at least one other computer system. When the cursor is located in a non-native portion in which data is displayed at a resolution different from a resolution in the native portion, the cursor control signal is scaled. The scaled cursor control signal is provided to the computer system to which the non-native portion is apportioned, and the cursor is moved in the non-native portion in accordance with the scaled cursor control signal.

### CROSS-REFERENCE TO RELATED APPLICATIONS

This application claims priority to U.S. Provisional Patent Application Ser. No. 61/468,376, filed Mar. 28, 2011, the entire disclosure of which is incorporated herein.

### FIELD

The present disclosure relates to apparatus and methods for operating a cursor manipulation device at multiple resolutions.

### BACKGROUND

This section provides background information related to the present disclosure which is not necessarily prior art.

Physicians who are performing medical procedures may coordinate the use of various separate medical systems for, e.g., imaging, device localization and navigation. Such systems may utilize control commands input by the physician, e.g., via computer mouse and/or keyboard. Such systems also may provide data on display monitors for viewing by the physician.

### SUMMARY

This section provides a general summary of the disclosure, and is not a comprehensive disclosure of its full scope or all of its features.

The present disclosure, in one implementation, is directed to a method of using a cursor control signal from a cursor manipulation device to move a cursor in a composite display having a native portion controlled by a native computer system and at least one non-native portion apportioned to at least one other computer system. When the cursor is located in a non-native portion in which data is displayed at a resolution different from a resolution in the native portion, the cursor control signal is scaled. The scaled cursor control signal is provided to the computer system to which the non-native portion is apportioned, and the cursor is moved in the non-native portion in accordance with the scaled cursor control signal.

In another implementation, the disclosure is directed to a method of moving a cursor in a display of a native computer system in which portions of the display are controlled by the native computer system and portions of the display are apportioned to at least one non-native computer system. When the cursor is located in a non-native portion of the display, cursor control signals from one or more cursor manipulation devices associated with the native computer system are modified, the modifying based on a difference in resolution of data in one or more portions of the display, before communicating the cursor control signals to a non-native computer system to change a display of the cursor in the non-native portion of the display.

In another implementation, the disclosure is directed to a method of providing cursor movement across a composite computer display having a portion used by a primary computer system and at least one portion used by at least one accessory computer system. The method includes modifying a cursor control signal from a cursor manipulation device associated with the primary computer system when a cursor is displayed in a portion of the composite display used by an accessory computer system, the modifying performed based on a difference, if any, between a resolution of the display portion in which the cursor is located and a resolution of the display portion used by the primary computer system.

In another implementation, the disclosure is directed to an apparatus including a primary computer system configured to display data at a native resolution in a native display portion on a composite display and to provide one or more display portions on the composite display for display of data from one or more accessory computer systems at one or more non-native resolutions. The apparatus is configured to: receive an input signal via a cursor manipulation device operable through the primary computer system for controlling a cursor on the composite display. From among the computer systems, the apparatus determines a target system to which the input signal is directed, the determining based on a target display portion in which the cursor is located. The apparatus uses the input signal to provide a cursor control signal for use by the target system in accordance with the native or non-native display resolution corresponding to the target system and to move the cursor in the target display portion.

In yet another implementation, the disclosure is directed to a method of providing cursor movement across a composite computer display having a portion used by a primary computer system and at least one portion used by at least one accessory computer system. The method includes modifying a cursor control signal from a cursor manipulation device associated with the primary computer system when a cursor is displayed in a portion of the composite display used by an accessory computer system, the modifying performed based on a difference in resolution of the display portion in which the cursor is located and resolution of a display controlled by the accessory computer system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a system configuration having a composite display in accordance with one implementation of the disclosure;

FIG. 2 is a schematic diagram of the architecture of a system implemented in accordance with one implementation of the disclosure;

FIG. 3 is a schematic diagram of some components of a system implemented in accordance with one implementation of the disclosure;

FIGS. 4A and 4B are views of a composite display, illustrating the use of a single input device to control multiple systems depending on the positioning of a cursor in accordance with one implementation of the disclosure;

FIGS. 5A and 5B are diagrams showing a number of components and systems networked via a USB controller in accordance with one implementation of the disclosure;

FIG. 6A is a diagram of an apparatus in accordance with one implementation of the disclosure;

FIG. 6B is a diagram of an apparatus in accordance with one implementation of the disclosure;

FIG. 7 is a flow diagram of a method of moving a cursor relative to a composite display in accordance with one implementation of the disclosure;

FIG. 8 is a diagram of an apparatus in accordance with one implementation of the disclosure; and

FIG. 9 is a diagram of an apparatus in accordance with one implementation of the disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

In various implementations of the present disclosure, apparatus and methods are provided that allow a user to operate a cursor manipulation device, e.g., a computer mouse, to manipulate a cursor at different resolutions and speeds dependent on a current mouse position and/or on a current system state. Such a device can be operable, for example, to control multiple systems via a composite display.

Although various implementations of the disclosure are described with reference to medical procedures and medical systems, the disclosure could be implemented in relation to many different types of computer systems, whether or not medically related. It should also be understood that the term “cursor manipulation device” is used broadly and may include any device used to point to or otherwise indicate a location on a display. Thus a “cursor manipulation device” may be, e.g., a computer mouse, track ball, joystick, touch screen monitor, stylus, light pen, head tracking device, track pad, keyboard, pressure-sensitive device, etc. Further, although implementations involving the use of a single cursor manipulation device are discussed in the disclosure, it is also contemplated that more than one cursor manipulation device could be used in some implementations. Still further, although implementations are described with reference to two-dimensional visual displays, the disclosure could be implemented in relation to other types of displays, including but not limited to volumetric displays. Additionally, the disclosure is not limited to the use of a single composite display. The disclosure could be implemented, for example, in relation to more than one display, including but not limited to one or more displays that are not composite.

When computer-controlled systems are used in a medical procedure, a physician may provide control input to the systems, e.g., via a computer mouse and/or keyboard, and receive feedback information, e.g., via a visual display. In some implementations of the present disclosure, information from two or more computer systems may be displayed in a composite display in which portions of the display are allocated to each computer system.

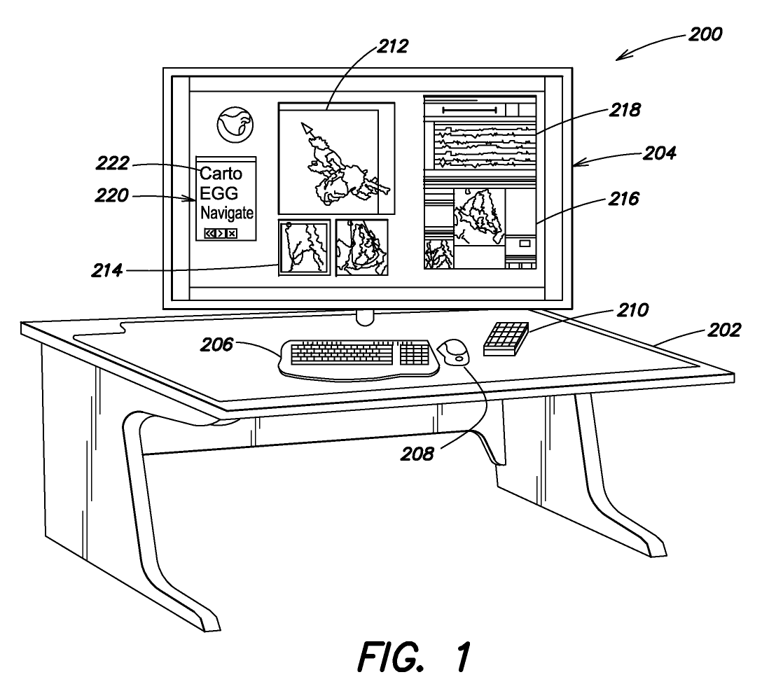

One such system arrangement is illustrated as 200 in FIG. 1, in which a work table 202 is shown with a consolidated display 204, a control key board 206, a control mouse 208, and a dedicated system controller 210 are shown. The consolidated display 204 has a portion 212 for displaying the associated display from a medical navigation system, such as a Stereotaxis' magnetic medical navigation system, available from Stereotaxis, Inc., St. Louis, Mo., although the display could be from some other medical navigation system. The consolidated display 204 has a portion 214 for displaying the associated display from a medical imaging system, such as a Siemens x-ray system, although the display could be from some other x-ray system, or from some other type of imaging system altogether, including MRI and ultrasound. The consolidated display 204 also has a portion 216 for displaying the associated display from a medical localization system, such as a Carto localization system, available from Biosense, although the display could be from some other medical localization system. The consolidated display 204 also has a portion 218 for displaying the associated display from an ECG system. The consolidated display 204 can have other portions for displaying the displays from other separate medical systems, and/or some of the portions 212, 214, 216, and 218 could be omitted or replaced. The consolidated display may also include a window 220 in which prompts 222, e.g., generated by the system, guide the user.

A single cursor is movable on the consolidated display 204 by using the keyboard 206 or mouse 208. The keyboard 206 and mouse 208 are functional to control the separate medical systems associated with the portion (e.g. 212, 214, 216, and 218) over which the cursor is positioned. Thus the user can move the cursor from portion to portion by manipulating the keyboard 206 or mouse 208, and when the cursor is in a particular portion of the consolidated display, use the keyboard 206 and mouse 208 to control the associated system. Thus with a single keyboard and mouse, the user can control all of the systems, simply by moving the cursor on the consolidated display 204. A dedicated controller 210 can be provided with buttons or other controls that operate one or more of the separate medical systems regardless of the position of the cursor on the consolidated display. This allows the user to immediately input commands to a system irrespective of the position of the cursor. The dedicated controller can operate just one of the systems, such as the navigation system, or it can have dedicated controls for two or more of the systems. The controls can be dedicated to particular functions, or they can be reprogrammable by the system based upon the context, or by the user, based upon preference.

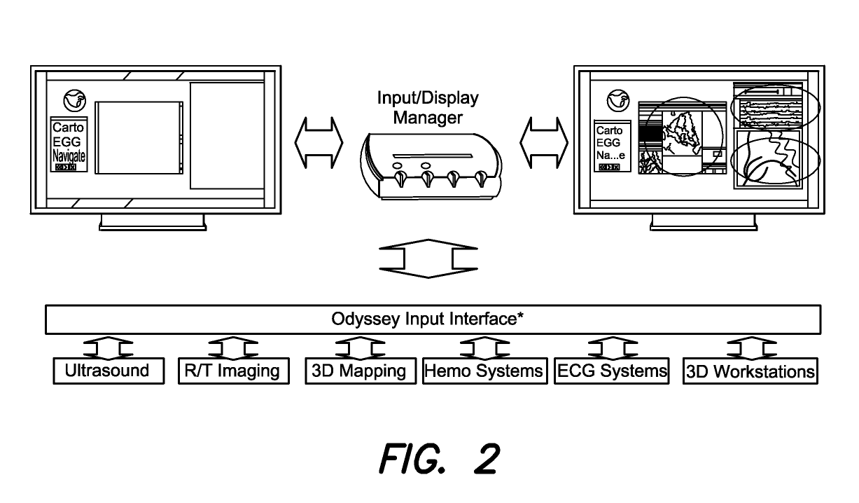

A possible system architecture is shown in FIG. 2. As shown in FIG. 2, a plurality of separate systems interface with an input/display manager. These systems can include, for example, an ultrasound system, a real time imaging system, a 3D mapping system, a Hemo system, an ECG system, and a 3D workstation. The input/display manager directs which of the displays of the various systems get displayed on the composite system, and manages their size and location, e.g., in accordance with a workflow plan, automatically updating the composite display each to the configuration appropriate for each step in the work flow. Regardless of the configuration, the user can control any of the systems displayed by moving the cursor over the appropriate portion of the composite display, and operating the graphical user interface of the system with the mouse and keyboard.

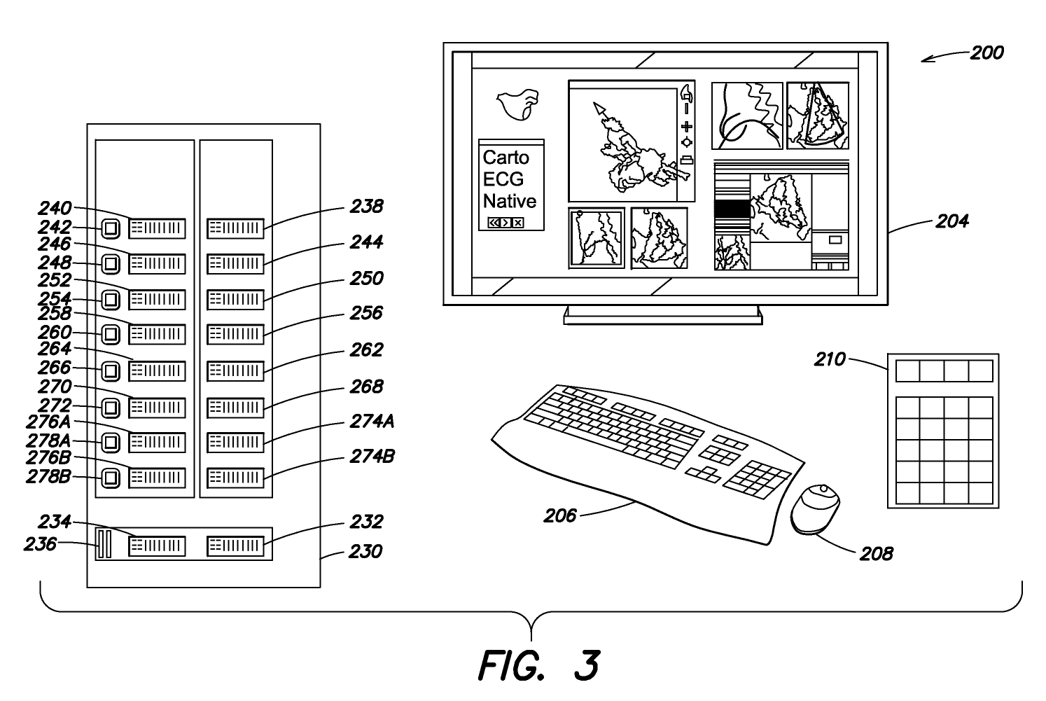

The components of the system 200 are shown schematically in FIG. 3. A connector plate for the input display manager is indicated as 230 in FIG. 3. The connector plate has a serial port 232 for connecting to the composite monitor 204 and a serial port 234 for connecting to the video card of the computer running the system 200, and a USB connector 236 for connecting to a USB port on the computer running the system 200. In addition the connector plate has monitor, video card, and USB connections 238, 240, and 242 for the separate navigation system; monitor, video card, and USB connections 244, 246, and 248 for the separate live ECG system; monitor, video card, and USB connections 250, 252, and 254 for the separate reference ECG system; monitor, video card, and USB connections 256, 258, and 260 for the separate x-ray imaging system; monitor, video card, and USB connections 262, 264, and 266 mapping/localization system; monitor, video card, and USB connections 268, 270, and 272 for the separate ultrasound system; and two sets of monitor, video card, and USB connections 274 A & B, 276 A & B, and 278 A & B for additional separate computer based medical systems.

This arrangement allows the user to connect separate systems together without modifying the individual systems, and control them from the composite display 204 using the keyboard 206 and mouse 208. The system 200 operates so that the mouse appears to move a cursor continuously across the composite display 204 across the portions that represent the displays of the individual systems, where the cursor is actually a cursor moving on the interface of the separate system, and across the portions of the composite display between those portions, where the cursor is the cursor of the interface of the system 200. By managing the cursor in this way, it appears to be a single cursor moving continuously over the display 204, even though it may actually be several cursors.

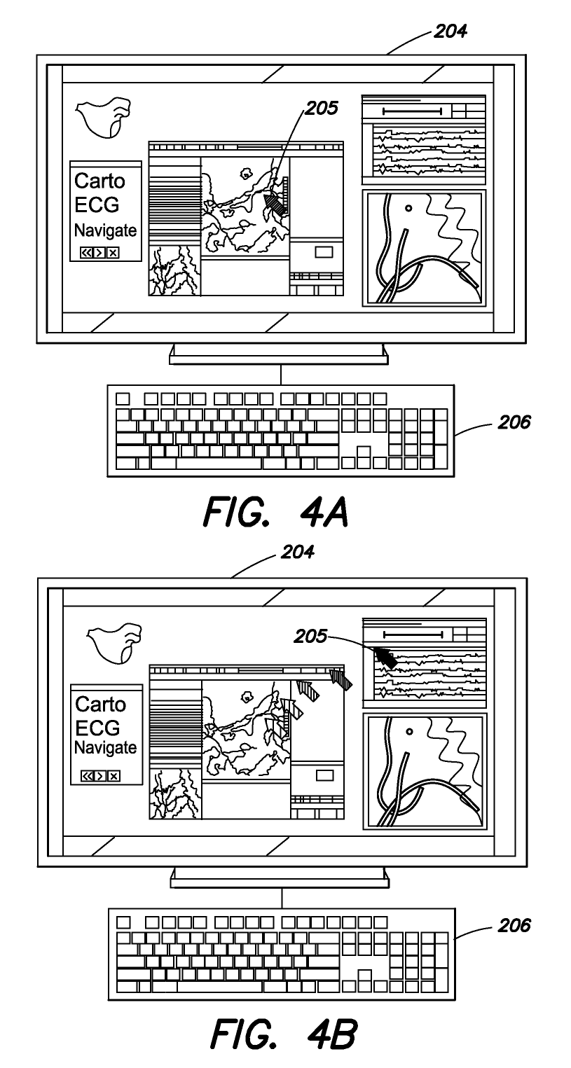

As shown in FIGS. 4A and 4B, when a cursor 205 appears in a particular portion of the screen, the keyboard 206 and mouse 208 operate to control the separate system in whose display the mouse is visible. Thus in FIG. 4A, the cursor displayed is the cursor in the Carto system, and operating the keyboard 206 operates the Carto system. In FIG. 4B, the cursor has been moved to the portion of the composite display showing the display of the ECG system. This is shown by the solid cursor arrow, the faded cursor arrows simply showing previous positions of the cursor, illustrating that the movement appears to the user to be continuous, even though in one embodiment it is not continuous (and instead is a series of the separate system cursor arrows bridged by the cursor arrow from the system). In FIG. 4B, since the cursor arrow is in the ECG portion of the display, the keyboard 206 operates in the ECG system.

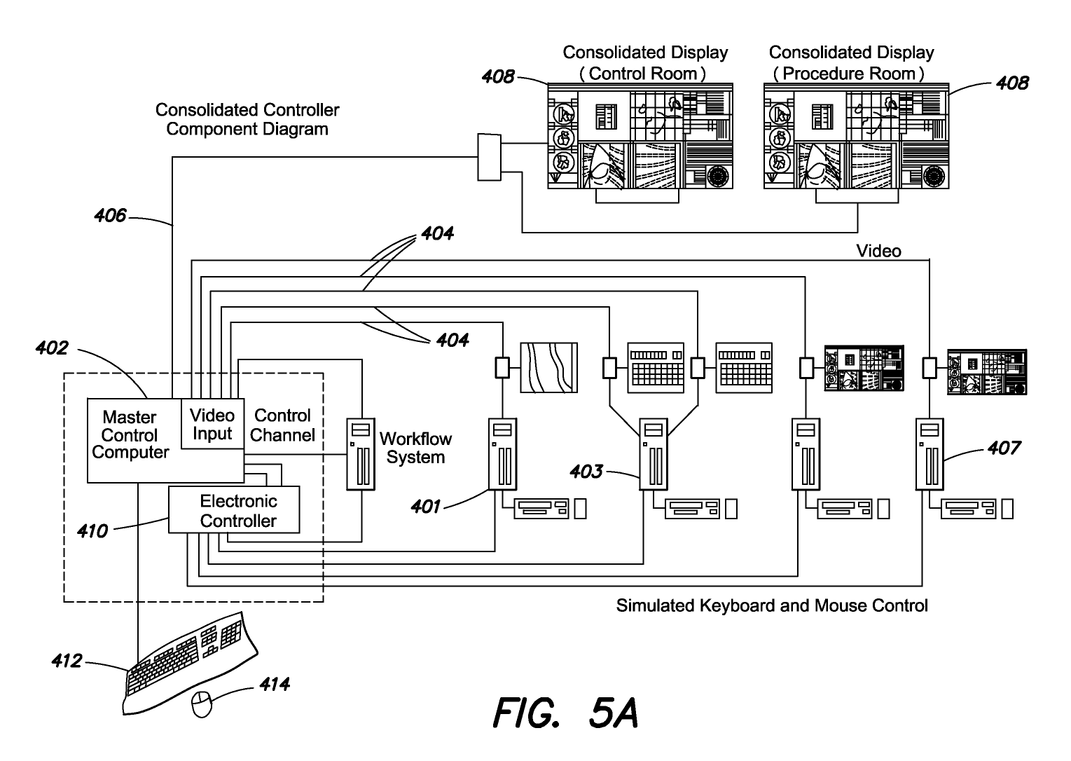

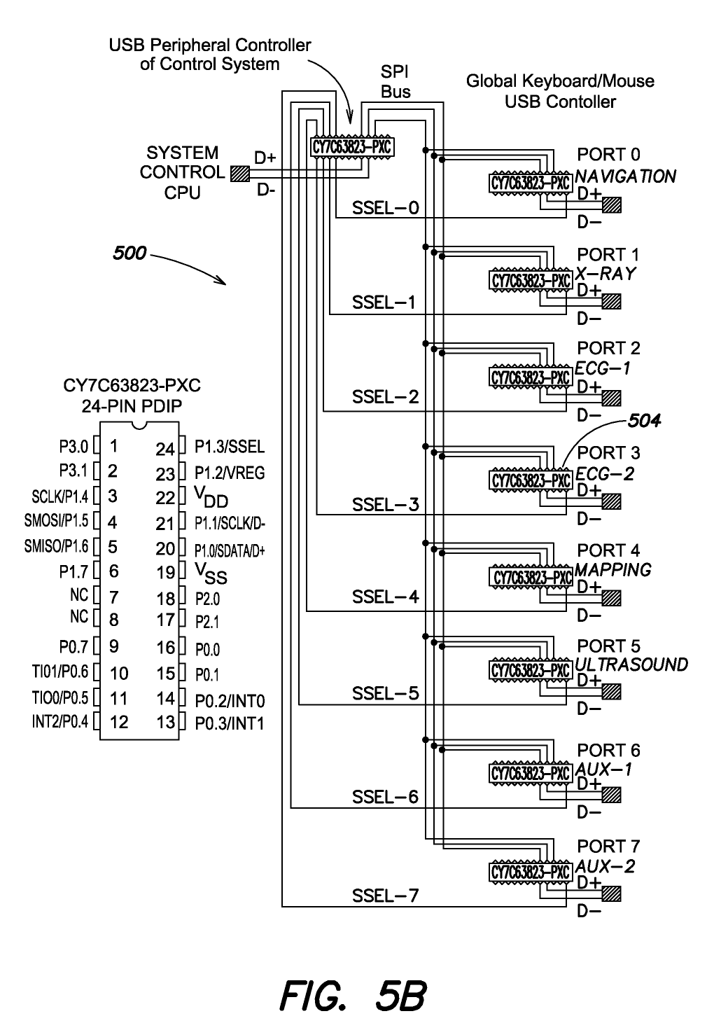

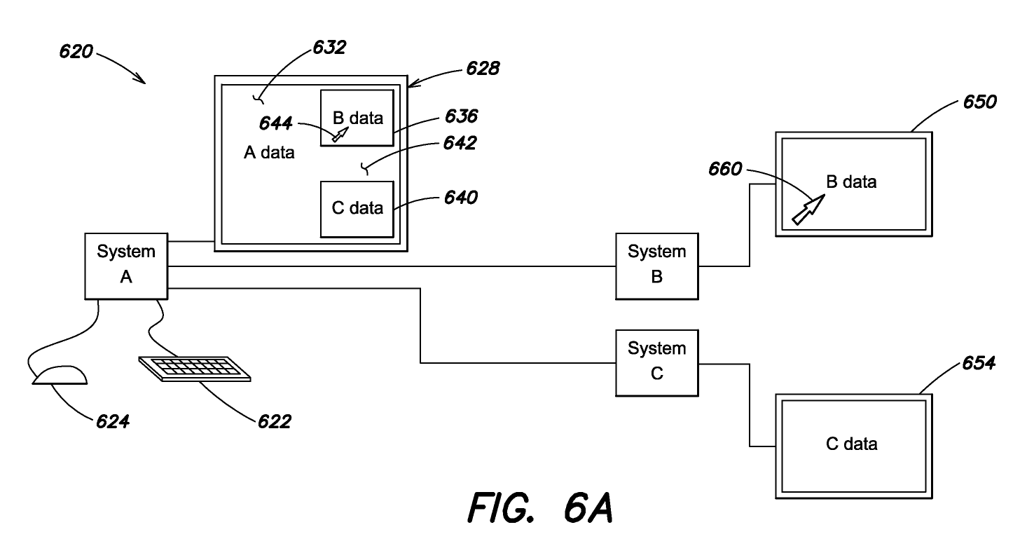

One embodiment of a seamless multi-system keyboard and mouse controller uses a USB implementation. FIG. 5A shows a general system diagram for such an embodiment. Master controller 402 receives video inputs 404 from a set of controlled medical systems or computers 401, 403, 407, and generates a composite video output 406 that is sent to at least one master screen(s) 408. Master controller 402 also provides inputs to electronic controller 410 that redirects command inputs such as test inputs from keyboard 412 to a selected controlled medical system or computer based on current cursor position as determined at least in part by position and movement of mouse 414. Other input signals to electronic controller 410 include mouse clicks and other inputs dependent upon specific UIF configuration(s).

FIG. 5B illustrates details of an example electronic control system that may be part of, or associated with, a master medical system or master computer. The control system has electronic circuits that send appropriate keyboard and mouse events to a controlled system, making that system appear to function as one selectable window among many other similarly controlled systems. The electronic control system utilizes standard computer interfaces including Universal Serial Bus (USB) to effect the keyboard and mouse control in such a way that the controlled system requires no specialized hardware or software to enable such control. The keyboard and mouse controller includes a master computer and consolidated display, a control program on the master computer system to arbitrate control events between multiple controlled systems, an electronic circuit 500 for simulating keyboard and mouse interfaces on controlled systems, and firmware programming to translate master control events into standard keyboard and mouse events for the controlled system. The firmware on the electronic controller utilizes a standard Human Interface Descriptor (HID) to allow the simulated mouse and keyboard events to be implemented with no hardware or software modifications of the controlled system.

As the operator uses the master control computer, the control software determines which controlled system should be subject to the operator's inputs. The control software then instructs the USB micro-controller 504 corresponding to the selected controlled system(s) to generate simulated keyboard and mouse events directly interpretable by the controlled system, such that controlled system(s) appears to seamlessly function within the context of the master system. The control system further uses a mouse control mode that allows the specific placement of the cursor to be specified by the master system, thus allowing the seamless motion of a cursor across many computer systems.

In some configurations a consolidated user interface may control a multiplicity of medical systems or computers, and a plurality of keyboard and mice combinations can be connected to the consolidated system to support at least two simultaneous controls operating seamlessly with the consolidated display. In some configurations, the position of each of one or more global cursors may be indicated with a graphic such as a circle, halo, or similar graphic differentiator presented as an overlay constantly displayed over all windows of the consolidated display. In this manner, as any of the mice is moved, the corresponding global cursor graphic is moved. The graphic may be designed so as not to block the central area of the global cursor position and to allow the native cursor of each system to appear in its center. When the global cursor position of each mouse is located in a distinct associated system window, each mouse may control its associated system independently without interference from any of the other mice, the native cursor of each system appearing in the center of each global cursor position graphic. Global input devices for multiple computer-controlled medical systems are further described in U.S. Pat. No. 7,567,233 and in U.S. patent application Ser. No. 12/505,192, the disclosures of which are incorporated herein by reference in their entirety.

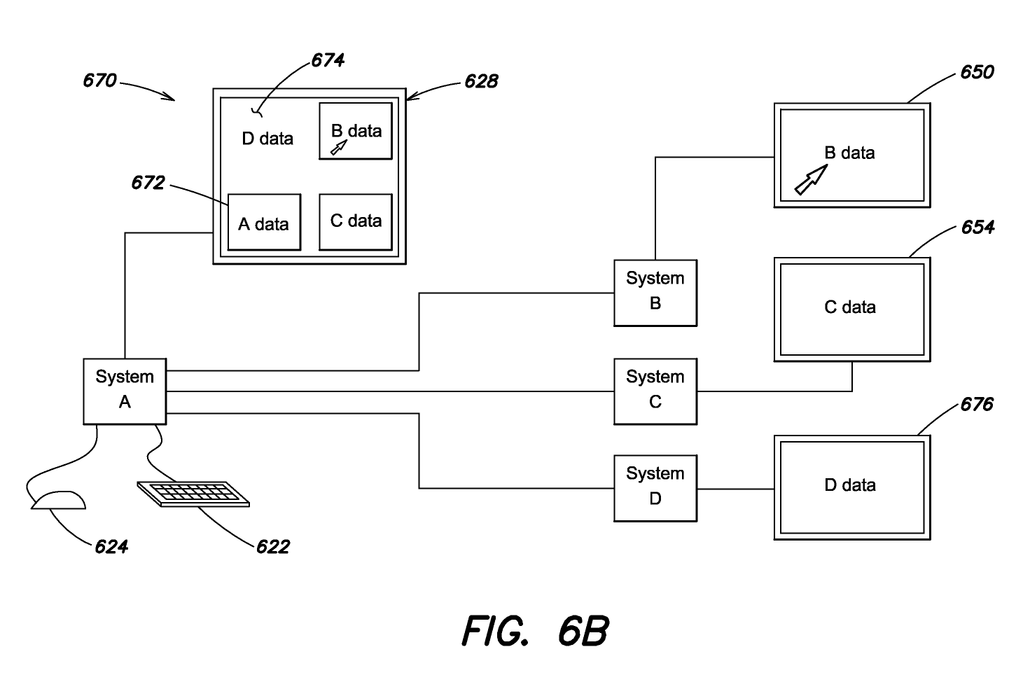

An apparatus in accordance with one implementation of the disclosure is indicated generally in FIG. 6A by reference number 620. A primary computer system A is connected with one or more accessory computer systems, e.g., accessory computer systems B and C. The primary computer system A includes a keyboard 622 and a cursor manipulation device, e.g., a mouse 624. A physician or other user may operate the mouse 624 to input control signals to computer systems A, B and/or C using a composite display 628.

Display portions 632, 636 and 640 of the composite display 628 are apportioned respectively to the computer systems A, B and C for display of data through the system A, which controls the composite display 628. Thus the display portion 632 may be referred to as a “native” portion of the composite display, and the display portions 636 and 640 may be referred to as “non-native” portions of the composite display. The native display portion 632 may include but is not limited to interstices 642 between the non-native display portions 636 and 640. It should be noted that although the non-native display portions 636 and 640 are shown as separate areas in FIG. 6A, display portions could be dynamically represented, e.g., as windows that might overlap and that could be moved and manipulated via the mouse 624.

The user may use the mouse 624 to move a cursor 644 in the composite display 628. Cursor movement may be into, across and/or out of the display portions 632, 636 and/or 640. The user may also “click” and/or otherwise activate the mouse 624 to provide cursor control signals for the composite display 628.

In the embodiment shown in FIG. 6A, the accessory system B has a native display 650 on which the system B may display visual data at a resolution that may be referred to as “native” to the system B. The accessory system C has a native display 654 on which the system C may display visual data at a resolution that may be referred to as “native” to the system C. The term “native” resolution is interpreted broadly in the present disclosure and may include, e.g., a display resolution of a system that natively displays data. Additionally or alternatively, a resolution of an image being natively displayed by a system may be referred to in this disclosure as a “native” resolution.

In various configurations an accessory computer system may include a mouse and/or may respond to mouse event signals by moving a cursor relative to visual data on a display native to that accessory system. It should be noted, however, that embodiments are possible in which an accessory computer system has neither a native hardware display nor a native hardware cursor manipulation device yet is capable of processing visual data as described in this disclosure. For example, in some implementations the accessory computer systems B and/or C may respond to control commands from the mouse 624 in relation to the composite display 628 as further described below, without using the native displays 650 or 654.

Each of the systems A, B and C may be capable of displaying visual data at one or more resolutions native to that system. When the cursor 644 is located in the native display portion 632 of the composite display 628, the system A uses cursor control signals from the mouse 624 to move the cursor 644 in the native display portion 632. The user thus may move the mouse 624, e.g., for a distance corresponding to one pixel in coordinates of a native resolution of the system A to obtain one pixel of cursor movement over data displayed in the native portion 632 of the composite display 628.

However, visual data output in the systems A, B and/or C could have the same or different resolutions when displayed in the composite display 628. In conventional systems, mismatch between data resolution and mouse commands might occur, e.g., as follows. Assume, for example, that a primary computer system and an accessory computer system each provide visual output at a native resolution of 2000×1000 pixels. If the primary system were to display the visual output from the accessory system at one-quarter size in a portion of a composite display, the resolution of the accessory system visual output in the display portion would be 500×250 pixels. If a user were to operate a mouse in the primary computer system to move a cursor in coordinates of the primary system's native resolution, one pixel of cursor movement over data in the accessory system's display portion would be tantamount to cursor movement over four pixels of the data as natively represented in the accessory system.

In contrast, in one implementation of the disclosure visual data from an accessory computer system B and/or C may be displayed in a non-native portion 636 and/or 640 of the composite display 628 and may be subjected to commands from the mouse 624 without resulting in mismatch between data resolution and mouse commands. The apparatus 620 allows a user to move the mouse 624, e.g., for a distance corresponding to one pixel in coordinates of a native resolution of the system B to obtain one pixel of cursor movement over system B data displayed in the non-native portion 636 of the composite display 628. To prevent mismatch between data resolution and mouse commands, the apparatus 620 may modify cursor control commands entered through the mouse 624.

For example, when the cursor 644 is located in a non-native display portion, e.g., in the non-native portion 636, the apparatus 620 may scale the cursor control signal from the mouse 624 in accordance with a native resolution of the accessory system B. The scaled cursor control signals are provided to the accessory system B, which responds by signaling native cursor movement in the system B. In the example embodiment shown in FIG. 6A, the accessory system B displays data in the native display 650 and also sends the same visual output to the non-native composite display portion 636 via the primary system A. The accessory system B uses the scaled cursor control signals to move a cursor 60 that is native to and displayed in the native display 50 of the system B. When the cursor 660 is displayed in the native display 650, the cursor 660 also is displayed as the composite display cursor 644 in the non-native portion 636 of the composite display 628.

In the apparatus 620 the composite display cursor 644 is a cursor native to the system A when the cursor is located in the native portion 632 and is a display of a cursor native to an accessory system B or C when the cursor is located in a non-native portion of the composite display 628. As the mouse 624 is operated to move the cursor 644 across the composite display 628, the cursor 644 may change appearance, speed, and/or acceleration as it is moved from one display portion to another display portion.

It should be noted that a native display portion of a composite display does not necessarily provide background areas as shown in FIG. 6A. For example, another apparatus configuration is indicated generally in FIG. 6B by reference number 670. A native display portion 672 of the primary system A is surrounded by a background display portion 674 apportioned to an accessory computer system D. In the present configuration the accessory system D also has a native display 676 on which the system D may display visual data at a resolution native to the system D.

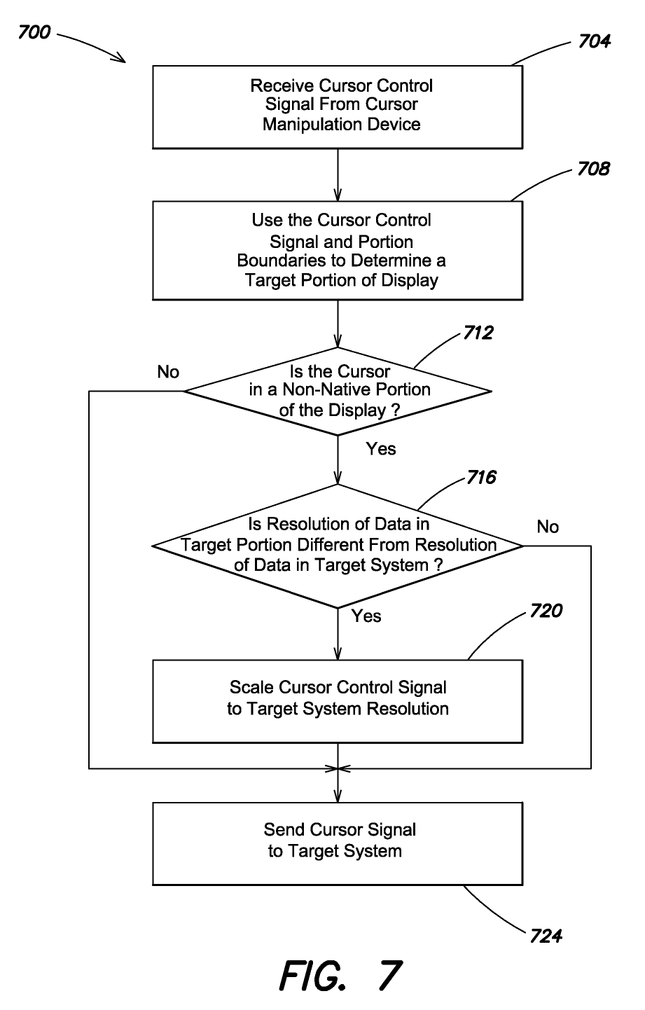

One implementation of a method of moving a cursor relative to a composite display is indicated generally in FIG. 7 by reference number 700 and shall be described with reference to the example apparatus 620 shown in FIG. 6A. In process 704 a cursor control signal is received, e.g., by the primary computer system A, from the mouse 624 as described with reference to FIG. 6A. In process 708 the cursor control signal and boundaries of the native and non-native portions are used to determine a target portion of the display 628, i.e., the portion in which the cursor 644 is currently located. If it is determined in process 712 that the target portion is a non-native portion of the display (in the present example, the non-native portions 636 or 640), then it is determined in process 716 whether resolution of data displayed in the target portion is different from resolution of the data in the target system, i.e., the accessory system B or C to which the target portion is allocated. If the resolutions are different, then in process 720 the cursor control signal is modified, e.g., scaled to obtain a cursor control signal that may be used in the target system to move a cursor in coordinates native to the target system. For example, if the cursor 644 is to be moved in the display portion 636 for the system B, then the cursor control signal is scaled to the resolution at which the system B outputs the display data. In process 724 the cursor control signal is sent to the target system for use by the target system, e.g., to move the cursor 644 in the target portion of the display.

In some implementations a cursor displayed in a composite display may be native to a primary system regardless of whether it may be located in a native or a non-native portion of a composite display. For example, in some cases it might be useful to display visual data from an accessory system in a non-native portion of a composite display at a resolution that is greater than the native resolution of the data in the accessory system. The data in the accessory system could be processed to obtain a clear image at the larger resolution in the composite display. A primary system mouse may be operated to move a cursor native to the primary system over the interpolated image in the non-native portion. The cursor control signal may be modified in accordance with the native resolution of the data as previously discussed with reference to FIG. 6A. In the present example, however, the accessory system applies the modified cursor control signal to simulate cursor movement while the primary system cursor is displayed in the non-native portion of the composite display. The primary system cursor movement is in accordance with the simulated cursor movement by the accessory system.

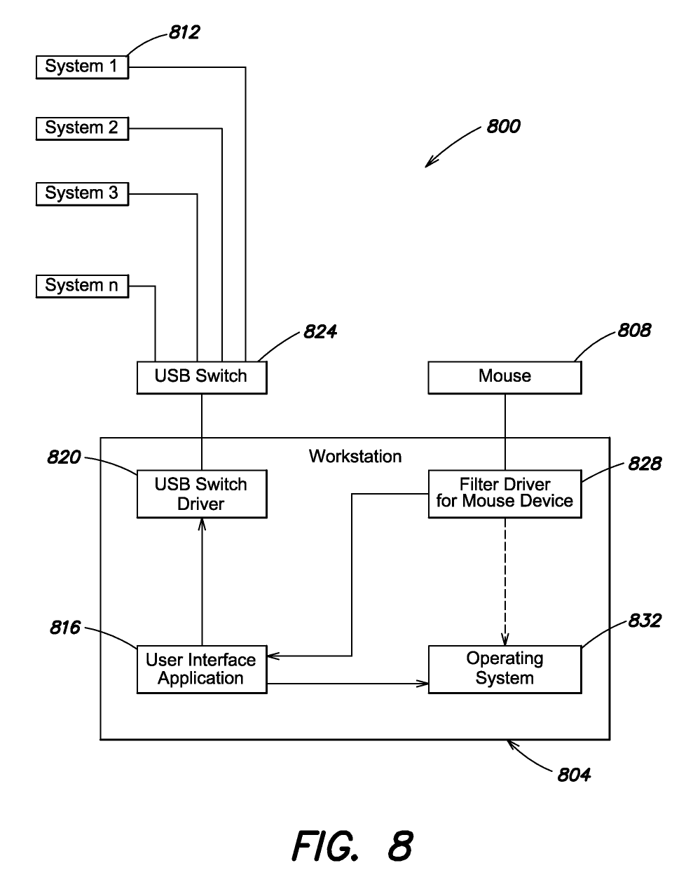

An apparatus in accordance with another implementation of the disclosure is indicated generally in FIG. 8 by reference number 800. The apparatus 800 may be used in the performance of medical procedures and includes a primary computer system, e.g., a workstation 804 for the Navigant™/Odyssey™ systems, available from Stereotaxis, Inc., St. Louis, Mo. The workstation 804, which may be remote from the site of the medical procedure, may be operated by a physician or other user, e.g., via a keyboard (not shown) and a mouse 808. In some configurations the mouse 808 may be remote from the workstation 804. For example, the workstation 804 may receive mouse events from a remote computer over a network, e.g., using remote control software available from TightVNC, http://www.tightvnc.com.

The workstation 804 is connected with a plurality of accessory computer systems 812 through which are provided capabilities such as imaging, localization and electrocardiography at the medical procedure site. An accessory system 812 may or may not include a native display and/or native cursor manipulation device. Each accessory system 812 is capable of processing cursor control signals at least to simulate movement of a cursor relative to visual data. The physician may control the systems 812 via the mouse 808 and one or more visual displays, which may include but are not limited to one or more composite visual displays, e.g., as previously discussed with reference to FIG. 6A.

The workstation 804 provides control of the systems 812 through a user interface application 816, a USB switch driver 820, a USB switch 824 and a software filter driver 828. The user interface application is, for example, a Navigant™ application by Stereotaxis, Inc. The user interface application 816 substantially continuously keeps track of, among other things, visual data sources available through the systems 812 and the native resolutions of the data sources.

When the user interface application 816 is not executing, a cursor control signal from the mouse 808 is passed to the operating system 832 of the workstation 804. In the present example implementation, the signal is passed to an application programming interface (API) subsystem of the workstation operating system 832, e.g., to the Windows Win32 subsystem, for standard cursor control signal processing for the workstation 804.

When the user interface application 816 is executing, the software filter driver 828 receives cursor control signals from the mouse 808. In a configuration in which the workstation 804 has a Windows operating system, the filter driver 828 may be configured, e.g., with the Windows Display Driver Model (WDDM) to intercept a message stream from the mouse 808. When the filter driver 828 receives a cursor control signal from the mouse 808, the filter driver 828 routes the signal to the user interface application 816 and thereby prevents or postpones standard operating system processing of the cursor control signal.

The user interface application 816 uses a current location of the cursor to determine a target system 812 or 804 for the cursor control signal. lf, e.g., the cursor is currently located on the Navigant™ application desktop and/or in a composite display portion allocated to the workstation 204, the cursor control signal is determined to be directed to the user interface application 816 itself. Accordingly the cursor control signal is sent to the workstation operating system 832, e.g., to the Windows Win32 subsystem, which may use the cursor control signal and a Win32 SendInput call to simulate mouse input to the user interface application 816.

If the cursor is determined to be located in a display portion allocated to one of the accessory computer systems 812, the user interface application 816 modifies the cursor control signal as appropriate for the target accessory system 812 as previously discussed. The user interface application 816 may transform and scale the cursor control signal coordinates to native coordinates of the target system 812, thereby transforming relative movement of the mouse 808 to obtain a relative or an absolute position of the cursor. The modified control signal is sent through the USB switch driver 820 and USB switch 824 to the target system 812, which may generate cursor movement in accordance with the scaled control signal. The user interface application 816 displays the cursor movement in the appropriate display portion for the target system 812.

It should be noted that many variations of hardware and/or software are possible in other or additional implementations of the disclosure. For example, a separate application could be provided to communicate with the filter driver 828 to perform some or all of the signal routing and/or other user interface application functionality described above. Additionally or alternatively, KVM switching could be provided in place of or in addition to USB switching of signals between the computer system 804 and accessory systems 812. Other operating systems could also be used in place of or in addition to Windows to provide equivalent functionality.

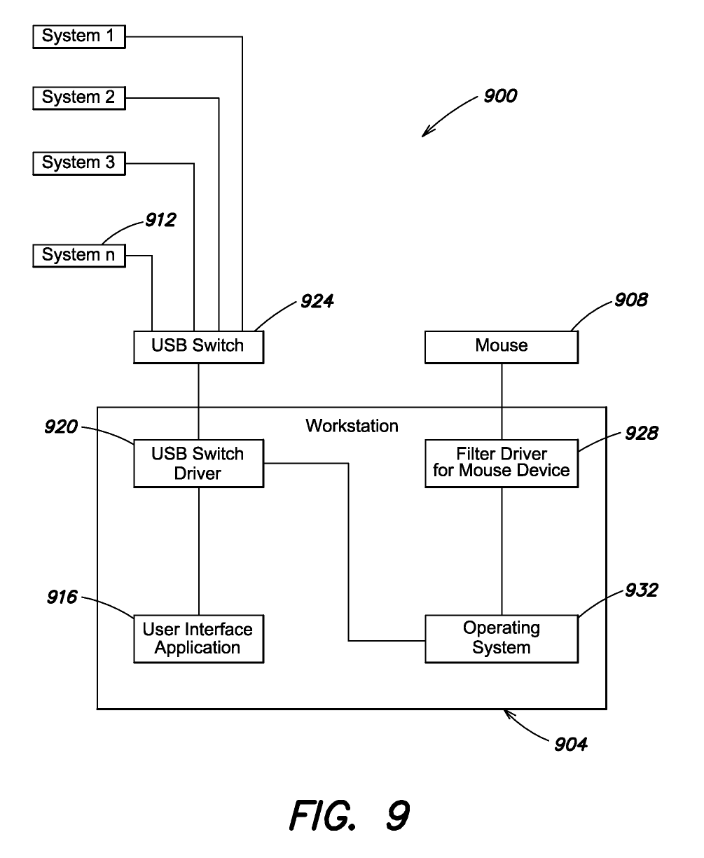

An apparatus in accordance with another implementation of the disclosure is indicated generally in FIG. 9 by reference number 900. The apparatus 900 may be used in the performance of medical procedures and includes a computer system, e.g., a workstation 904 for the Navigant™/Odyssey™ systems, available from Stereotaxis, Inc., St. Louis, Mo. The workstation 904, which may be remote from the site of the medical procedure, may be operated by a physician or other user, e.g., via a keyboard (not shown) and a mouse 908.

The workstation 904 is connected with a plurality of accessory computer systems 912 through which are provided capabilities such as imaging, localization and electrocardiography at the medical procedure site. The physician may control the systems 912 via the mouse 908 and one or more visual displays, which may include but are not limited to one or more composite visual displays as shown in FIG. 6A. The workstation 904 provides control of the systems 912 through a user interface application 916, a USB switch driver 920, a USB switch 924 and a filter driver 928. The user interface application 916 is, for example, a Navigant™ application by Stereotaxis, Inc.

In some implementations of the disclosure, the software filter driver 928 substantially continuously keeps track of visual data sources available through the systems 912 and the native resolutions of the visual data sources. The filter driver 928 also receives cursor control signals from the mouse 908. An operating system 932 of the workstation receives, e.g., from the filter driver 928 and the user interface application 916, substantially continuous information describing the states of the systems 912 and of the workstation 904. In a configuration in which the workstation 904 has a Windows operating system, the filter driver 928 may be configured, e.g., with the Windows Display Driver Model (WDDM) to intercept a message stream from the mouse 908.

When the filter driver 928 receives a cursor control signal from the mouse 908, the driver passes the signal to the operating system 932. if the user interface application 916 is not executing, the operating system 932 passes the signal, e.g., to the Windows Win32 subsystem for standard cursor control signal processing. If the user interface application 916 is executing, the operating system 932 uses the current location of the cursor and boundaries of display portions to determine a target system for the cursor control signal. lf, e.g., the cursor is currently located on the application interface 916 desktop and/or in a composite display portion allocated to the workstation 904, the cursor control signal is determined to be directed to the user interface application 916 itself. Accordingly the operating system 932 may process the control signal as a mouse input signal to which the user interface application 916 may respond.

If the operating system 932 determines that the cursor is located in a display portion allocated to one of the accessory computer systems 912, the operating system 932 modifies the cursor control signal as appropriate to the target accessory system 912. Specifically and for example, the operating system 932 may transform and scale the cursor control signal coordinates to the native coordinates of the target system 912. The modified control signal is sent through the USB switch driver 920 and USB switch 924 to the target accessory system 912, which may move the cursor in accordance with the scaled control signal. The user interface application 916 displays the cursor movement in the appropriate display portion for the target system 912.

Implementations also are contemplated in which mouse input may be routed to multiple systems and/or display portions without using a driver. For example, in a primary system that uses a Windows operating system, APIs made available through Windows may be used in a coordinated way to filter mouse movement. An API SetWindowsHookEx may be used to receive mouse input in the form of cursor coordinates and to conditionally reject cursor movement. An API WM_INPUT may be used to track mouse signaling independently, e.g., for each of a plurality of accessory systems. The API SendInput may be used to inject new movement. In one implementation WM_INPUT may issue calls for SendInput to generate mouse movement signals to replace mouse input rejected by SetWindowsHookEx. In other implementations, user code may be provided that performs some or all of the foregoing functions.

The foregoing apparatus and methods can make it possible to move a mouse or other cursor manipulation device with greater precision over a composite display than would be possible using conventional systems and methods. For example, imprecision can be avoided when a cursor is moved over a composite display portion in which there is a non-integral ratio of cursor coordinate resolution to native resolution of the displayed data. In a conventional system in which a ratio between the native resolution of a display and the native resolution of displayed data is, for example, 1 to 2.5, movement of a mouse by one pixel could generate movement of either two or three pixels in native coordinates of the displayed data. Such a lack of precision can be problematic in some situations, for example, if a user must move a cursor as close as two or three pixels to “grab” a particular object such as a side of a window in a display.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of using a cursor control signal from a cursor manipulation device to move a cursor in a composite display having a native portion controlled by a native computer system and at least one non-native portion apportioned to at least one other computer system, the method comprising:
when the cursor is located in a non-native portion in which data is displayed at a resolution different from a resolution in the native portion, scaling the cursor control signal and providing the scaled cursor control signal to the computer system to which the non-native portion is apportioned, and moving the cursor in the non-native portion in accordance with the scaled cursor control signal.

2. The method according to claim 1 wherein the cursor control signal from the cursor manipulation device is scaled in accordance with a resolution of the computer system to which the non-native portion is apportioned.

3. The method according to claim 1 wherein the cursor control signal from the cursor manipulation device is scaled based on a difference in resolutions of the native portion and the non-native portion.

4. The method according to claim 3 wherein the cursor control signal is scaled based on one or more ratios of the resolutions of the native portion and the non-native portion.

5. The method of claim 1 wherein the cursor is moved in the non-native portion by the computer system to which the non-native portion is apportioned.

6. The method of claim 1 wherein the cursor is moved in the non-native portion by the native computer system.

7. A method of moving a cursor in a display of a native computer system in which portions of the display are controlled by the native computer system and portions of the display are apportioned to at least one non-native computer system, the method comprising:
when the cursor is located in a non-native portion of the display, modifying cursor control signals from one or more cursor manipulation devices associated with the native computer system, the modifying based on a difference in resolution of data in one or more portions of the display, before communicating the cursor control signals to a non-native computer system to change a display of the cursor in the non-native portion of the display.

8. The method according to claim 7 wherein the cursor control signals are modified in accordance with a resolution of the non-native computer system.

9. The method according to claim 8 wherein the cursor control signals are scaled in accordance with the resolution of the non-native computer system.

10. The method according to claim 7 wherein the one or more cursor manipulation devices include a keyboard.

11. A method of providing cursor movement across a composite computer display having a portion used by a primary computer system and at least one portion used by at least one accessory computer system, the method comprising:
modifying a cursor control signal from a cursor manipulation device associated with the primary computer system when a cursor is displayed in a portion of the composite display used by an accessory computer system, the modifying performed based on a difference, if any, between a resolution of the display portion in which the cursor is located and a resolution of the display portion used by the primary computer system.

12. The method of claim 11, further comprising sending the cursor control signal to and for use by the computer system using the portion of the display in which the cursor is located to move the cursor.

13. The method of claim 11, further comprising:
sending the cursor control signal to the computer system using the portion of the display in which the cursor is located; and
using the primary computer system to display the cursor.

14. The method of claim 10, wherein a speed of cursor movement is changed upon a change of cursor display between the display portion used by the primary computer system and a display portion used by an accessory computer system.

15. An apparatus comprising:
a primary computer system configured to display data at a native resolution in a native display portion on a composite display and to provide one or more display portions on the composite display for display of data from one or more accessory computer systems at one or more non-native resolutions;
the apparatus configured to:
receive an input signal via a cursor manipulation device operable through the primary computer system for controlling a cursor on the composite display;
from among the computer systems, determine a target system to which the input signal is directed, the determining based on a target display portion in which the cursor is located; and
use the input signal to provide a cursor control signal for use by the target system in accordance with the native or non-native display resolution corresponding to the target system and to move the cursor in the target display portion.

16. The apparatus of claim 15 further configured to scale the input signal to obtain the cursor control signal.

17. The apparatus of claim 15 wherein the target system is determined to be the primary computer system.

18. The apparatus of claim 15 wherein the target system is determined to be an accessory computer system.

19. The apparatus of claim 15 further configured to determine the target system based on one or more system states of the computer systems.

20. The apparatus of claim 19 further comprising a filter driver configured to route the input signal (a) for use by the primary computer system independent of the one or more accessory computer systems and/or (b) to a module of the apparatus for the determining of the target system.

21. The apparatus of claim 20 wherein the filter driver is configured to receive information as to states of the one or more accessory computer systems and the one or more non-native resolutions.

22. A method of providing cursor movement across a composite computer display having a portion used by a primary computer system and at least one portion used by at least one accessory computer system, the method comprising:
modifying a cursor control signal from a cursor manipulation device associated with the primary computer system when a cursor is displayed in a portion of the composite display used by an accessory computer system, the modifying performed based on a difference in resolution of the display portion in which the cursor is located and resolution of a display controlled by the accessory computer system.

23. The method of claim 22, further comprising sending the cursor control signal to and for use by the accessory computer system using the portion of the display in which the cursor is located to move the cursor.

24. The method of claim 22, further comprising:
sending the cursor control signal to the accessory computer system using the portion of the display in which the cursor is located; and
using the primary computer system to display the cursor.

25. The method of claim 22, wherein a speed of cursor movement is changed upon a change of cursor display between the display portion used by the primary computer system and a display portion used by an accessory computer system.
